(19) United States
(12) Patent Application Publication
(10) Pub. No.: US 2009/0205170 A1
(43) Pub. Date: Aug. 20, 2009

(54) Hinge Assembly

(76) Inventor: Chao-Chi Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/031,781

(22) Filed: Feb. 15, 2008

(51) Int. Cl. E05D 11/08

(52) U.S. Cl. 16/337

(57) ABSTRACT

A hinge assembly a hinge assembly suitable for coupling a notebook computer base to display includes a first coupling member for coupling to the base, a second coupling member for coupling to the display, a positioning means for supporting the display at various angular positions relative to the base, a friction means for increasing resistance to movement throughout range of motion of the hinge assembly while decreasing torque and pressure load transmitted to the positioning means.

### BACKGROUND OF THE INVENTION

1. Field of the Invention

The present invention relates to a hinge assembly, in particular to a hinge assembly for electronic apparatus.

2. Description of the Related Art

Referring to Taiwan Patent Publication No. 556,861, there is disclosed a hinge mechanism for supporting a display at various angular positions relative to a base. The hinge mechanism includes a first coupling member 10 for coupling to the base, a second coupling member 20 for coupling to the display, and two resilient members 30 disposed oppositely and frictionally rotatable with respect to a wall of the second coupling member 20 for supporting the display at various angular positions with respect to the base. However, a problem with such hinge mechanism is that torque transmitted to and pressure load on the resilient members 30 can break the resilient members 30 easily.

The present invention is, therefore, intended to obviate or at least alleviate the problems encountered in the prior art.

### SUMMARY OF THE INVENTION

It is therefore an object of the present invention to provide a hinge assembly that increases life of components, which is used for supporting a display at various angular positions relative to a base.

Accordingly, the object is achieved by providing a hinge assembly that includes a first coupling member for coupling to the base, a second coupling member for coupling to the display, a positioning means for supporting the display at various angular positions relative to the base, a friction means for increasing resistance to movement throughout range of motion of the hinge assembly while decreasing torque and pressure load transmitted to the positioning means, a biasing member for imparting biasing force to the positioning means and the friction means, and a plurality of lubricating washers for lubricating the friction means.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a hinge assembly in accordance with a first embodiment of the present invention.

FIG. 2 is an exploded perspective view of the hinge assembly of FIG. 1.

FIG. 3 is an exploded perspective view of the hinge assembly of FIG. 1 taken from a different angle of view.

FIG. 4 is a cross-sectional view taken along line 4-4 of FIG. 1.

FIG. 5 is a cross-sectional view taken along line 5-5 of FIG. 1.

FIG. 6 is similar to FIG. 4, but shows the hinge assembly in another position.

FIG. 7 is a cross-sectional view taken along line 7-7 of FIG. 6

FIG. 8 is similar to FIG. 5, but shows the hinge assembly in another position.

### DETAILED DESCRIPTION OF THE PREFERRED EMBODIMENT

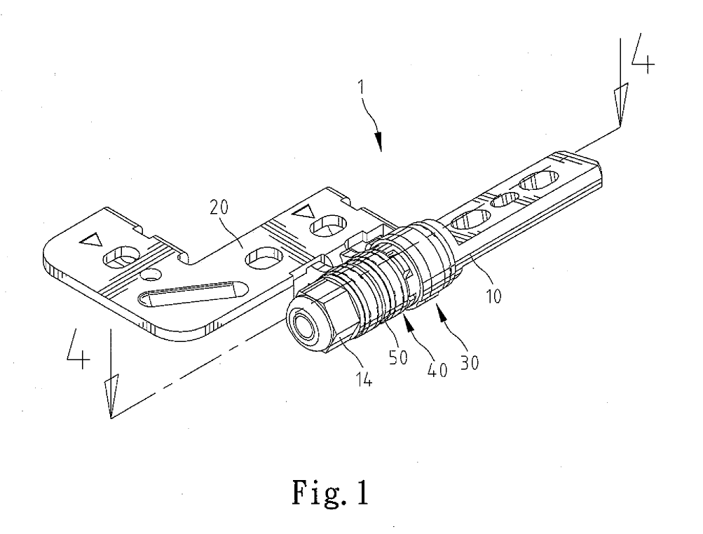

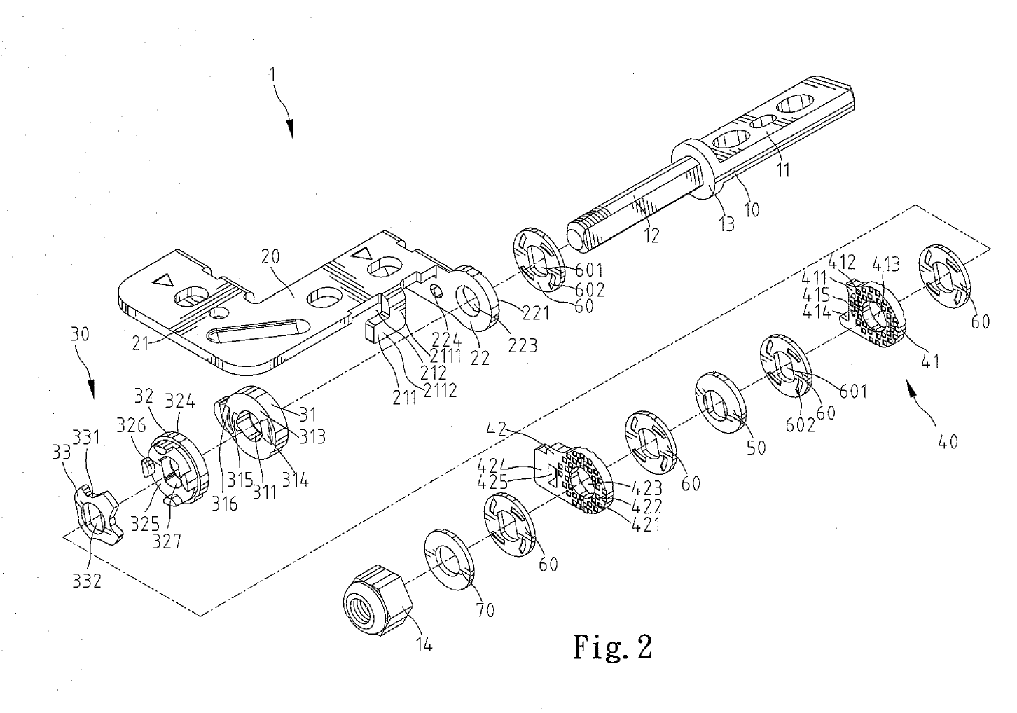

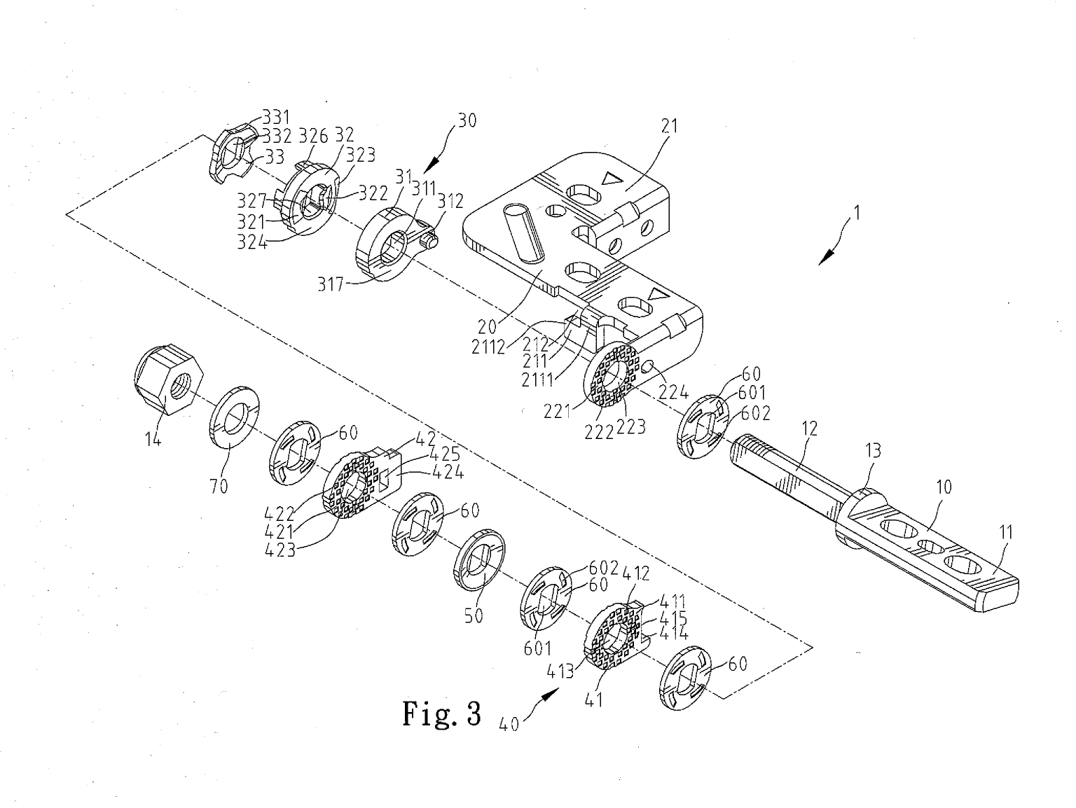

Referring to FIGS. 1 through 4, a hinge assembly suitable for coupling a notebook computer base to a display includes a first coupling member 10 for coupling to the base, a second coupling member 20 for coupling to the display, a positioning means 30 for supporting the display at various angular positions relative to the base, a friction means 40 for increasing resistance to movement throughout range of motion of the hinge assembly while decreasing torque and pressure load transmitted to the positioning means 30, a biasing member 50 for imparting biasing force to the positioning means 30 and the friction means 40, and a plurality of lubricating washers 60 for lubricating the friction means 40.

The first coupling member 10 has a first section 1, a second section 12 and a shoulder 13 formed therebetween. The second section 12 pivotally receives the positioning means 30, the friction means 40, the biasing member 50, the plurality of lubricating washers 60 and threadly engaging with an end cap 14 for retaining the aforementioned elements 30, 40, 50, 60 on the second portion 12. Furthermore, a spacer 70 is provided between one of the plurality of lubricating washers 60 and the end cap 14 so as to prevent the end cap 14 from fretting the lubricating washer 60.

The second coupling member 20 includes a connection end 21, a pivotal end 22 extended from the connection end 21. The pivotal end 22 includes a hole 223 inserted therein the second section 12 of the first coupling member 10 and can be rotated with respect to the second section 12 of the first coupling member 10. The pivotal end 22 further includes a friction face 221 facing the shoulder 13, and the friction face 221 has a plurality of dents 222 for keeping lubricant. Furthermore, an anchor 211 has a first portion 2111 extended from the connection end 21, a second portion 2112 extended from the first portion 2111, and since the second portion 2112 is spaced from the connection end 21, a gap 212 is defined between the connection end 21 and the second portion 2112.

The positioning means 30 includes a first detent 31 having a first face 313 and a second face 317 and a hole 311 transversely extending therebetween that receives the second section 12 of the first coupling member 10 and can be rotated with respect to the second section 12 of the first coupling member 10. The first face 313 has a first ridge 314, a second ridge 315, and a third ridge 316 disposed at different radii from the hole 311, and the second and third ridges 315 and 316 are opposite to the first ridge 314. The second face 317 has a catch 312 extended therefrom that is received in an orifice 224 so that when second coupling member 20 rotates, the first detent 31 can be rotatable together.

The positioning means 30 further includes a second detent 32 having a first face 324, a second face 325 and a hole 327 transversely extending therebetween that receives the second section 12 of the first coupling member 10 and can be rotated in concert with the second section 12 of the first coupling member 10. The first face 324 has a first indentation 321, a second indentation 322, and a third indentation 323 formed thereon complemently receivable in the first, second, third ridges 314, 315, 316 respectively. The second face 325 has four stubs 326 formed thereon. Furthermore, the positioning means 30 includes a resilient member 33 positioned against the second face 325. The resilient member 33 is formed in a shape of a dome with a predetermined curvature and includes four recessed edges 331 and a hole 332. The four recessed edges 331 correspondingly surround four stubs 326 of the second face 325 respectively. The hole 332 allows insertion of the second section 12 of the first coupling member 10.

The friction means 40 includes a first friction member 41 having two opposed friction faces 411 and a hole 413 transversely extending therebetween that receives the second section 12 of the first coupling member 10 and can be rotated with respect to the second section 12 of the first coupling member 10. Each friction face 411 has a plurality of dents 412 for keeping lubricant. In addition, the first friction member 41 includes a protrusion 414 and a space 415 delimiting a portion of periphery of the first friction member 41 and a portion of protrusion 414 that slidably receives the second portion 2112 of the anchor 211 of the second coupling member 20.

The friction means 40 further includes a second friction member 42 having two opposed friction faces 421 and a hole 423 transversely extending therebetween that receives the second section 12 of the first coupling member 10 and can be rotated with respect to the second section 12 of the first coupling member 10. Each friction face 421 has a plurality of dents 422 for keeping lubricant. In addition, the second friction member 42 includes an extension 424 having an orifice 425 extending therethrough that slidably receives the second portion 2112 of the anchor 211 of the second coupling member 20.

The sliding movement of the first and second friction members 41 and 42 are dependent upon engagement/disengagement of the first, second, third ridges 314, 315, 316 with the first, second, third indentations 321, 322, 323 respectively and the biasing member 50 is suitable for urging the second detent 32 toward the first detent 31.

Each of the plurality of lubricating washers 60 includes two opposed faces having a plurality of radially disposed recesses 602 for keeping lubricant individually, and a hole 601 transversely extending therebetween that receives the second section 12 of the first coupling member 10. The recesses 602 are of arcuate shape so as to achieve ease of movement throughout the range of motion of the hinge assembly.

In this preferred embodiment, two lubricating washers 60 are positioned on the two friction faces 411 of first friction member 41 respectively, two lubricating washers 60 are positioned on the two friction faces 421 of the second friction member 42 respectively. One lubricating washer 60 is positioned between the pivotal end 22 of the second coupling member 20 and the shoulder 13 of the first coupling member 10.

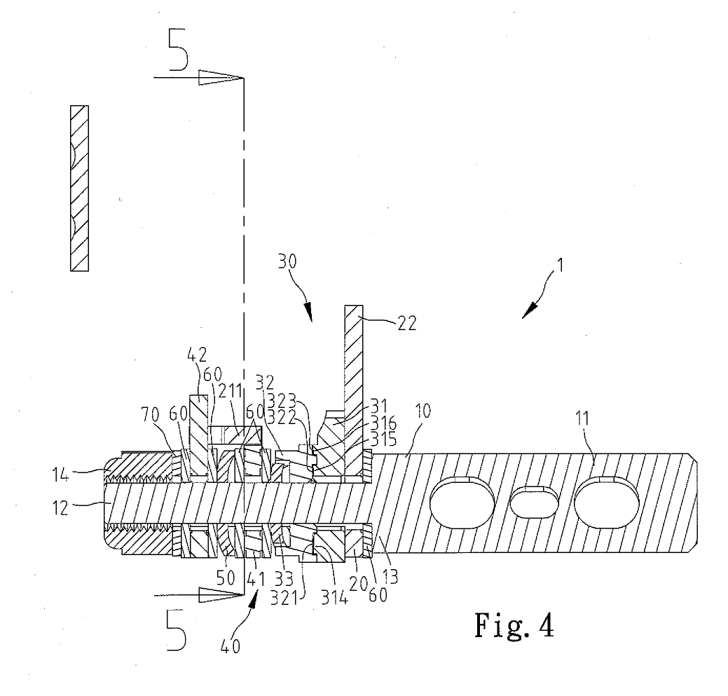

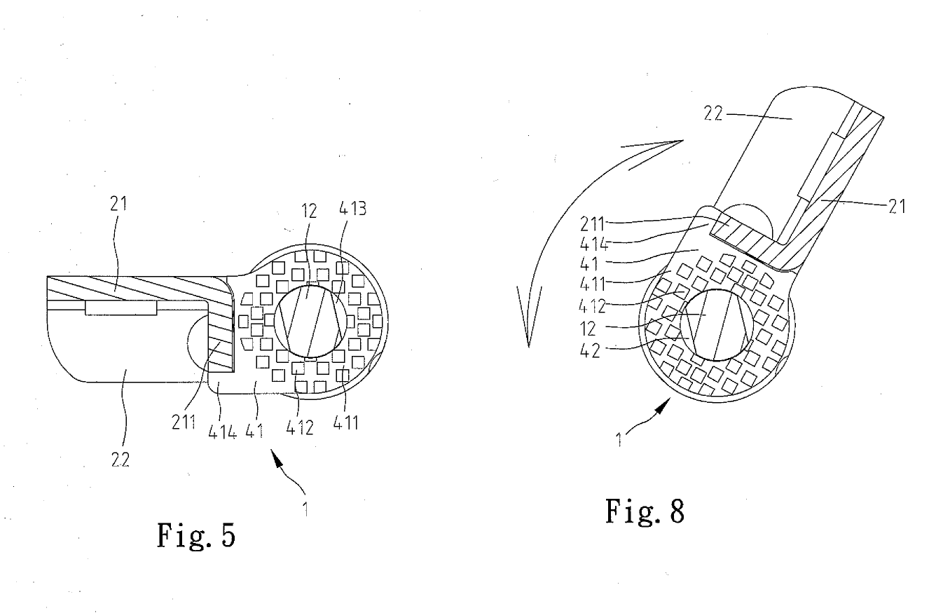

Referring to FIGS. 4 and 5, when the hinge assembly is in a closed state, the first, second, third ridges 314, 315, 316 of the first detent 31 are completely received in the first, second, third indentations 321, 322, 323 of the second detent 32 respectively.

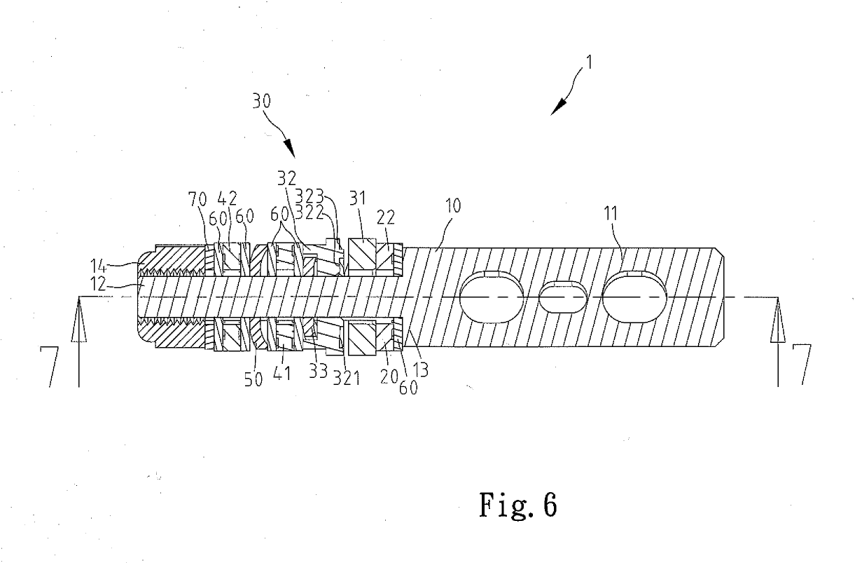

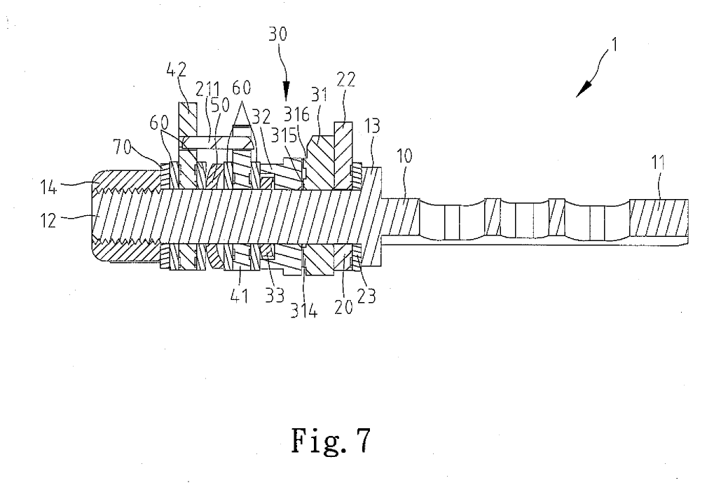

Referring to FIGS. 6 through 8, when gradually opening the hinge assembly, the second coupling member 20 is rotated relative to the first coupling member 10, the first, second, third ridges 314, 315, 316 of the first detent 31 are gradually rotated to disengage from the first, second, third indentations 321, 322, 323 of the second detent 32 respectively, and the first and second friction members 41 and 42 are rotated relative to the lubricating washers 60 so as to increase resistance to movement throughout range of motion of the hinge assembly, and slidably moved along the second portion 2112 of the anchor 21 1 of the second coupling member 20 so as to decrease torque and pressure load transmitted to the positioning means 30.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

What is claimed is:

1. A hinge assembly comprising:
a first coupling member including a first section and a second section;
a second coupling member, pivotally connected to the second section of the first coupling member and including an anchor extended therefrom;
a positioning means, pivotally connected to the second section of the first coupling member and including a first detent, a second detent and a resilient member, the first detent including at least one ridge formed on a first face, the second detent including at least one indentation formed on a first face corresponding to the at least one ridge respectively, and the resilient member being formed in a shape of a dome with a predetermined curvature positioned on a second surface of the second detent;
a friction means, pivotally connected to the second section of the first coupling member and including a first friction member and a second friction member both slidably engaged with the anchor; and
a biasing member pivotally connected to the second section of the first coupling member for imparting biasing force to the positioning means and the friction means; and
wherein the second coupling member is rotatable with respect to the first coupling member;
wherein the second detent is rotatable with respect to the first detent and the at least one ridge is selectively engagable with the at least one indentation respectively; and
wherein sliding movement of the friction means is dependent upon engagement and disengagement of the at least one ridge with the at least one indentation respectively.

2. The hinge assembly as claimed in claim 1 wherein the anchor comprises a first portion extended form the second coupling member and a second portion extended from the first portion and spaced from the second coupling member.

3. The hinge assembly as claimed in claim 2 wherein the first friction member comprises a protrusion and a space delimiting a portion of periphery of the first friction member and a portion of protrusion for receiving the second portion of the anchor.

4. The hinge assembly as claimed in claim 2 wherein the second friction member comprises an extension having an orifice for receiving the second portion of the anchor.

5. The hinge assembly as claimed in claim 1 wherein the first and the second friction members comprises two opposed friction faces individually, each opposed friction face includes a plurality of dents formed thereon.

6. The hinge assembly as claimed in claim 5 wherein the first friction member comprises a protrusion and a space delimiting a portion of periphery of the first friction member and a portion of protrusion for receiving the second portion of the anchor.

7. The hinge assembly as claimed in claim 5 wherein the second friction member comprises an extension having an orifice for receiving the second portion of the anchor.

8. The hinge assembly as claimed in claim 1 further comprising a plurality of lubricating washers pivotally connected to the second section of the first coupling member, each lubricating washer includes two opposed faces having a plurality of recesses.

9. The hinge assembly as claimed in claim 8 wherein the plurality of recesses are of arcuate shape.

10. The hinge assembly as claimed in claim 1 wherein the first coupling member comprises a shoulder formed between the first and second sections.

11. The hinge assembly as claimed in claim 1 wherein the second coupling member comprises a pivotal end having a hole inserted therein the second section of the first coupling member and a friction face facing the shoulder.

12. The hinge assembly as claimed in claim 11 wherein the friction face comprises a plurality of dents formed thereon.

13. The hinge assembly as claimed in claim 9 wherein the first friction member is positioned between two of the lubricating washers, the second friction member is positioned between the other two of the lubricating washers.

14. The hinge assembly as claimed in claim 9 wherein the second coupling member comprises a pivotal end having a hole inserted therein the second section of the first coupling member and a friction face facing the shoulder.

15. The hinge assembly as claimed in claim 14 wherein one of the lubricating washers is positioned between the friction face of the pivotal end and the shoulder.
